(19) United States
(12) Patent Application Publication
(10) Pub. No.: US 2011/0094107 A1
(43) Pub. Date: Apr. 28, 2011

(54) Small Electrical Appliance For Removing Hairs

(76) Inventors: Martin Ring, Glashuetten (DE); Bernhard Kraus, Braunfels (DE); Christian Neyer, Eschborn (DE); Robert Schaefer, Frankfurt (DE); Uwe Schober, Glashuetten (DE); Frank Ziegler, Karben (DE)

(21) Appl. No.: 12/980,991

(22) Filed: Dec. 29, 2010

Related U.S. Application Data
(63) Continuation of application No. PCT/EP2009/003601, filed on May 20, 2009.

(30) Foreign Application Priority Data
Jul. 1, 2008 (DE) 102008031132.4

(51) Int. Cl. B26B 19/38; B26B 19/28

(52) U.S. Cl. 30/43.1; 30/42

(57) ABSTRACT

The invention relates to a small electrical appliance for removing hairs, with a handpiece extending in the direction of a center axis and provided with front and rear sides and side faces, and with an operating head which is secured on the handpiece via a retaining device and has an operating unit. The operating unit is composed of at least one operating element which is set in motion via a drive member by an electrical drive motor formed in the small appliance, such that, when the operating unit slides along the skin surface of a user, hairs are removed by the operating unit. The retaining device is connected to the handpiece via guide means in such a way that, when a force (F1 or F2) acts on the operating head in the guiding direction, at least a lateral movement (c or d) of the operating head relative to the handpiece takes place.

### CROSS REFERENCE TO RELATED APPLICATION

This application is a continuation of prior co-pending International Application No. PCT/EP2009/003601, filed May 20, 2009, designating the United States.

### FIELD OF THE INVENTION

The present invention relates to a small electrical appliance for removing hairs.

### BACKGROUND OF THE INVENTION

From U.S. Pat. No. 6,301,786 B1, an electrically operated small appliance for removing hairs, in this case an electrical shaving apparatus, is known, in which the operating head, with its integrated operating unit, can be pivoted back and forth relative to the handpiece about a rotation point 8 situated on the longitudinal axis of the shaving apparatus; this pivoting is indicated here by arrow direction 7. Here the operating unit comprises at least one operating element that is driven so as to oscillate and is formed as an undercutter, on which there abuts from above, in a manner capable of sliding, a shaving foil provided with openings. The shaving foil forms the outer cutter of the operating unit. In addition to the pivot movement, the operating head is also slidingly height-adjustable in the direction of the longitudinal axis of the shaving apparatus, as indicated here by arrows 9. These compensating movements are intended to enable the operating head to better conform to the skin surface when the shaving foil is pressed against the skin surface of a user, in order to thus be able to achieve better shaving results.

Furthermore, from GB 2266070 A, an electrically operated small appliance for removing hairs, in this case also a shaving apparatus, is known in which the operating head is pivotable about a virtual rotation point 76, which here is situated at the point of intersection of the outer surface of the operating unit with the longitudinal axis of the shaving apparatus. Here as well, the operating unit comprises an outer cutter and a undercutter (the latter is not shown), the outer cutter being formed by a perforated shaving foil. According to FIGS. 3 through 5, at the operating head there engage, in an articulated fashion, two rod-shaped connecting elements that extend vertically and that are connected to one another in an articulated fashion via two angular levers that extend in the transverse direction. The angular levers are fastened in a stationary fashion to the housing of the small appliance via bearing bushings. Owing to this arrangement, the operating head is forced to rotate about virtual rotation point 76. Identical connecting elements are also formed on the rear side of the small appliance, in the same arrangement and design. In FIGS. 6A through 6D, the operating unit is additionally also pivotably mounted in the operating head, but here the pivot axis of the operating unit runs perpendicular to the pivot axis of the operating head. This pivot system is also intended to achieve the best possible shave, because the operating unit conforms well to or hugs the skin surface.

From US 2006/0265880 A1 there also is known an electric shaving apparatus designed in the form of a small appliance, in which operating unit 13 inserted in operating head 10 is also movably mounted. In addition, operating head 10 is held and centered in bearing bushings 70 via pins 105. In this shaving apparatus, drive motor 8 is fastened to operating head 10 and, via a drive pin 81, drives operating element 30, in this case a plurality of undercutters of the operating unit, in an oscillating fashion. In order to enable operating head 10 to better follow the surface of the skin during shaving, the operating head is pivotable, via its pins 105, in bearing shells 70 formed on a ring 7 fixed to the housing. Ring 7 is constructed so as to be symmetrical to the center axis of operating head 10 (FIG. 4), such that two bearing shells 70 in each case are arranged symmetrically on both sides of the center axis. According to FIG. 4, the center axis of operating head 10 extends so as to be inclined forward relative to the longitudinal axis of the handpiece.

If operating head 10 according to FIG. 1 is now pressed downward from above on the left side by a vertical downward-acting force component, operating head 10 pivots counterclockwise against the force of left spring 77, during which process pins 105 then lift out of bearing shells 70, while right pins 105 on the other hand are pressed into right bearing shells 70 by the force of right spring 77. During this movement, operating head 10 thus pivots about the midpoints of right pins 105. If operating head 10 is pressed by a force acting on the right side from above on the operating unit, operating head 10 pivots clockwise, and right pins 105 in the process move out of, or detach from, right bearing shells 70 according to FIG. 1, while left pins 105 are pressed into left bearing shells 70. This measure is intended to enable operating unit 13 to follow the contour of a skin surface particularly well.

Furthermore, from U.S. Pat. No. 6,261,301 B1 an electrical small appliance for removing hairs is known. Here, the electrical small appliance is an epilation device, which is used to pluck out hairs. Here as well, on the upper end of the handpiece an operating head is fastened to a retaining device, the operating head having at least one operating element that is set into rotation by an electric drive motor. The rotating operating unit has plucking elements 16 that move toward one another or away from one another, into which hairs can penetrate when the elements are open or situated at a distance from one another; the hairs are then grasped by the closing plucking elements as the operating unit rotates further, and are clamped and finally pulled out. Here, the operating head is fastened immovably to the retaining device.

Lastly, from EP 0 745 461 B1 an electrical small appliance for removing hairs of the type described above is known. Here as well, the electrical small appliance is a shaving apparatus that, according to FIG. 1, comprises a handpiece 1 and a retaining device 9, 10 formed on the upper, head end. Retaining device 9, 10 has receiving bores 12 at its upper end into which there engage pins 11 that protrude from the side faces of operating head RK. The connecting line of the two center axes of pins 11 forms the pivot axis (not shown) of operating head RK. Inserted into operating head RK is an operating unit 13, 15, 14 comprising three outer cutters 16, 20, 17 formed parallel alongside one another and undercutters 21, 34, 22 abutting the underside thereof, the undercutters serving as operating elements.

The outwardly situated outer cutters 16, 17 are formed by shaving foils that are curved outward and perforated by openings, while associated undercutters 21, 22 comprise disk-shaped blades that are situated alongside one another and connected to one another and that are curved outward. The disk-shaped blades are moved back and forth in an oscillating fashion by a drive device (not shown) formed in handpiece 1, via an upwardly oriented drive pin 6.

Third operating unit 15, which extends between the two operating units 13, 14, is what is known as an intermediate trimmer, that is intended to remove, during the shaving process, hairs that stand out a little further. Intermediate trimmer 15 comprises a doubly angled outer cutter 20 provided with transverse slits, on the underside of which there abuts a likewise doubly angled undercutter 34, also provided with transverse slits, that is likewise driven in an oscillating fashion by drive pin 6.

Operating unit 13, 15, 14, extends on the one hand parallel to the pivot axis of operating head RK, and on the other hand extends perpendicular to the longitudinal axis of handpiece 1. Side faces 7, 8 laterally bound the front and rear side of handpiece 1. Operating unit 13, 15, 14 is guided on operating head RK so as to be displaceable; i.e. through external pressure on operating unit 13 and/or 15 and/or 14, this operating unit is able to yield, due to its mounting by springs in operating head RK, as is shown for example in FIG. 9b. As soon as the pressure from above on operating unit 13 and/or 15 and/or 14 decreases, the operating unit returns to its initial position according to FIG. 9a. In addition to this movement, operating head RK is itself also mounted in retaining device 9, 10 so as to be capable of pivoting toward the front and the back by a predetermined angle (FIGS. 24, 25), so that when there are forces acting from the front or from the rear on operating head RK during shaving, this operating head can pivot about its pivot axis. In this way, a largest possible shaving surface of operating unit 13, 15, 14 comes into contact with the surface of the skin, because operating head RK is better able to follow the contour of a skin surface. In this way, a shorter shaving time is achieved, and at the same time the shaving results are improved as well.

### SUMMARY OF THE INVENTION

In one embodiment, the present invention creates a small electrical appliance for removing hairs with which even better results are achieved during a hair removal process through even better adaptation of the operating unit to the skin surface. At the same time, the time required for removing the hairs is shortened due to easier handling of the small appliance, and at the same time protection of the skin is achieved.

If, according to one embodiment of the present invention, between the retaining device and the handpiece guide means are formed such that when forces are directed onto the operating head there results a displacement of the operating head relative to the handpiece, then when the operating unit glides along the surface of the skin of a user during a hair removal process, the operating unit can better follow the contour of the skin surface, resulting overall in improved hair removal with increased skin protection. The operating head thus no longer pivots, as described in the prior art, about one or two fixed pivot points formed on the handpiece; rather, according to the present invention it can now move toward the sides relative to the handpiece.

This lateral displacement occurs whenever the operating unit is pressed against the surface of the skin of a user with a certain contact pressure, while simultaneously being moved in the direction of the lateral displacement. The frictional force that arises in the process, running in the direction opposite to the displacement force, exerts a transverse force component on the operating head that ultimately results, with the aid of the guide means, in a lateral displacement of the operating head relative to the handpiece. This lateral displacement of the operating head according to the present invention protects the skin surface and also results in a faster hair removal, which is particularly sought after given the faster pace of life today. The operating unit formed in the operating head can for example be a plucking device, a cutting device for removing hair, or some other device, the operating unit of which comes into contact with the skin surface of a user, and in the process should follow the contour of the skin surface as well as possible.

The operating head is capable of being automatically reset to its initial position via springy resetting means; i.e. if it is released after a lateral displacement, it automatically returns to its initial position. Preferably, spring elements are selected as resetting devices that engage on one or both sides on the operating head or on the guide means, the spring elements always enabling a center positioning of the operating head after an application of force has ceased.

The operating head may be connected via at least two connecting elements going out from the handpiece, the connecting elements having articulation devices that enable an articulated connection of the handpiece relative to the operating head. As articulation connections, preferably film hinges, elastically deformable bending points, spherical bearings, ball joints, or any other joint mechanisms known in mechanical engineering may be used. If only two connecting elements are selected, these must be situated as far as possible away from one another and must have bearing points that are dimensioned so large that the operating head is stably mounted and guided thereon, and for example does not tip to the side. Preferably, the connecting elements engage at opposite corners of the operating head, in order to achieve a stable guiding of the operating head with bearing points that are made suitably large.

In another embodiment, the features of the present invention result in a bearing of the operating head that is particularly resistant to warping, because here four connecting elements have been selected that are connected in each case to the operating head via four joints and to the handpiece via four joints. Thus, here the guide means are advantageously borne and coupled by four-joint systems formed on opposite sides of the small appliance. Two connecting elements in each case are situated at the same height. Of course a three-joint system would also be possible; in this case, two connecting elements are situated at the same height while the third connecting clement advantageously engages on the operating head on the other side, centrically relative to the other two connecting elements.

So that, when there is lateral displacement of the operating head, the operating head will extend parallel to the connecting lines that connect the joints at the handpiece, the four-joint system forms a parallelogram. The four-joint system is defined by the connecting lines that connect the joints to one another. While it is true that the connecting elements are displaced in straight lines parallel to one another during the lateral movements of the operating head, the operating head also moves closer to the handpiece, which, however, is negligible in the case of small lateral displacement paths, and thus also does not adversely affect the hair removal process. However, the coupling at the transition from the drive element to the operating element must be formed such that this path is compensated by the coupling without losses of force transmission or path transmission. The position of the rotation point of the four-joint system can be adjusted within wide ranges by varying the dimensions of the four-joint system. Thus, the longer the connecting elements are, and the further the joint points are situated from one another laterally, the larger are the paths that can be traveled by the operating head given even small displacement angles in the four-joint system, and the smaller is the amount by which the operating head approaches the handpiece.

In another embodiment, the four-joint system is formed by a trapezoid, the joints having the shorter distance being formed on the retaining device and the joints having the larger distance being formed on the handpiece. This is selected in this way so that the operating head fastened to the retaining device will be supported on a broader, more stable base. The trapezoidal arrangement additionally also has the advantage that given small displacement paths, the operating head maintains a nearly constant distance from the handpiece. A further advantage results in that, in addition to its lateral displacement, the operating head is also rotated or pivoted clockwise or counterclockwise about the joints of the retaining device, so that a combined sideways pivot movement results therefrom. Thus, when the operating head is for example displaced to the left, it is then also rotated slightly in the clockwise direction about its fixed joint points. When the operating head is displaced to the right, then it is also rotated slightly in the counterclockwise direction about its fixed joint points.

In another embodiment, if the small appliance is viewed from the front, the operating head is displaced toward the side faces, that is to say from left to right or vice versa. It should also be noted here that in the initial position of the small appliance, the two four-joint systems are situated symmetrically relative to a common center axis; i.e., if the small appliance is viewed vertically from the front, the four-joint systems coincide.

In a further specific embodiment, there is a lateral displacement of the operating head from the front to the rear or vice versa, viewing the small appliance from the front. Here as well, it is to be noted that all four-joint systems on the small appliance are formed so as to be symmetrical relative to a center axis on this and the other side; i.e. the front four-joint system coincides with the other four-joint system when the small appliance is viewed vertically from the left or from the right. In this arrangement, the operating unit also runs from left to right or vice versa.

In another embodiment, the joint devices comprise pins running in bores. The bores, preferably in bearing eyes, can be formed either on the retaining device or on the handpiece, or also on the two connecting elements. Correspondingly, the pins are then formed on the retaining device or on the handpiece. If the parts are shaped from plastic, such an embodiment can easily be integrally formed thereon. This also holds for injection-molded parts. As a result of these guide means, the operating head can pivot not only toward the sides, but can also pivot about the joints to a certain degree.

In another embodiment, however, film hinges may also be used as joints; these can be manufactured particularly economically and easily using injection methods, and such hinges also enable a movement of the retaining device relative to the handpiece. Film hinges are particularly easy to produce during the shaping of plastic parts by forming very thinned-out points between connecting elements. Of course, however, ball joints or other joint systems known to the design engineer of the device may also be used here.

A further specific embodiment is provided regarding a movement system in which the connecting elements no longer comprise webs with joints, but instead comprise webs having at least partly springy elements. In this embodiment, joints can be avoided entirely, because the springs, in addition to forming the resetting device, also enable a lateral movement in conjunction with the pivot movement about fastening points B1, B2. This specific embodiment can be realized particularly economically and with little expenditure of time and effort. Here, however, the spring elements must be made so stable that they reliably guide the retaining device and the operating head on the handpiece; i.e., in addition to a laterally directed pivot movement of the operating head, the operating head must otherwise maintain a stable position relative to the handpiece in order to be able to permanently resist the contact pressure. Plate springs, spiral springs, torsion springs, elastomers, or other shaped springs may be used as spring elements.

Owing to the features of another embodiment, the bearing part also now pivots about a bearing affixed thereto in the housing of the handpiece, resulting in a particularly pronounced lateral displacement of the operating head. In order to keep the system in equilibrium here, the mounting is arranged between fastening points B1, B2 and B3, B4 on the bearing part. Owing to this arrangement, the bearing part always recenters itself; i.e., the operating head always returns to its initial position after a shaving process. However, resetting springs that promote a centered orientation of the system can additionally also act on the bearing part from the sides. This arrangement results in a particularly elastic bearing both in the direction of pivot and toward the sides, because the downwardly drawn elongated arms create connecting elements extending over a greater length, via which larger movements of the operating head can be enabled with small shaving forces.

If, according to another embodiment, the connecting elements are formed completely from plate springs, the operating head is then mounted with particular elasticity toward the sides. The plate springs thus form the connecting elements that connect the handpiece to the operating head. The connecting elements extend from a bearing part formed in the handpiece to flexurally rigid arms that extend downward away from the operating head and to the free ends of which the connecting elements are fastened. Preferably, two arms, which can be made of sheet metal or reinforced plastic, extend downward from the retaining device. Due to the arms being drawn downward, particularly long plate springs can be selected, which provide a high degree of elasticity and flexibility of the operating head. In order to further increase the elasticity of the plate springs, openings or thinned areas can be formed on same.

According to another embodiment, the connecting points of the connecting elements to the bearing part can be welded, screwed, riveted, insert molded or glued, like the connecting points to the free ends of the arms. Of course, other fastening solutions known to a design engineer of the device are also conceivable; these are not mentioned here for the sake of simplicity.

The features of another embodiment result in a small appliance in which the operating head with its operating unit is able to follow the surface of the skin of a user in an extremely flexible manner. For this purpose, the operating head can move not only to the side from the left to the right and vice versa, but can also pivot toward the front or toward the rear and vice versa about a pivot axis. At the same time, when there is pressure on the operating unit this operating unit can also sink into the operating head against spring forces. Through these measures, the operating head can react not only to a lateral movement but also to a movement from the front toward the rear, and from above onto the operating head, as a result of which the operating unit conforms to the skin surface in an optimal manner. Thus, in this arrangement, the operating unit can move in three different planes. An operating head with an operating unit having such flexibility can be used in all small appliances in which the greatest possible contact of the skin surface of a user with the operating unit is required.

The features of another embodiment result in a further small appliance in which the operating head with its operating unit can also follow the skin surface of a user with a high degree of flexibility. Here, the operating head can be displaced not only from the front to the rear relative to the handpiece, but can also pivot clockwise or counterclockwise about the pivot axis, which runs from the front to the rear, viewed vertically from the front. At the same time, when there is pressure onto the operating unit this operating unit can also sink into the operating head against spring forces, the pivot axis being situated perpendicular to the operating unit. Here, the difference from another embodiment, discussed above, is that the lateral displacement of the operating head now runs from the front to the rear, that is to say in the same direction as the pivot axis. Here as well, the operating unit can move in three different planes. An operating head with operating unit having such flexibility can also be used in all small appliances in which the greatest possible contact of the skin surface of a user with the operating unit is required.

In order to avoid elaborate transmission devices from the operating head to the handpiece, according to another embodiment, both the operating head and the drive motor are formed in the retaining device. The retaining device thus bears both the operating head and the drive motor, so that only the electrical supply system, preferably the rechargeable batteries, the on-off switch, and any electrical control and display devices that may be present, are formed in the handpiece. This results in a simplified design of the small appliance, and can also make repair easier.

If, according to another embodiment, the drive motor is also formed in the operating head, these then form a unit that pivots together about the pivot axis of the operating head, thus enabling a particularly simple mechanical design. In this arrangement the handpiece may have formed therein only the electrical supply system, preferably the rechargeable batteries, the on-off switch, and any electrical control and display devices that may be present, thereby enabling the housing to have small dimensions.

If, according to another embodiment, the operating head is situated in the retaining device separately from the drive motor, this reduces the oscillating mass of the operating head; in this case, however, a mechanical transmission must be created from the drive motor, situated fixedly in the retaining device, to the operating head pivoting about its pivot axis.

However, according to the features of another embodiment it is completely conceivable to form the operating head in the retaining device and to form the drive motor in the handpiece; the operating element must then be connected to the drive element via a coupling element. This variant solution is indicated if there is sufficient space in the handpiece.

According to the features of another embodiment, the small appliance is an epilation device in which the operating unit comprises a rotating plucking drum on which clamping elements are formed as operating elements that open and close when the plucking drum rotates, such that when the plucking drum glides over the surface of the skin of a user, hairs enter into the clamping elements, are clamped there as the rotation continues, and are subsequently plucked out. Because according to the present invention the plucking drum is mounted in a retaining device which, in turn, is connected to the handpiece via elastic connecting elements, the plucking drum can also react to lateral movements by moving to the side relative to the handpiece while also pivoting about the connecting elements to a small degree. Here, in the one specific embodiment the connecting elements are connected both to the retaining device and to the handpiece via joints, while in another specific embodiment the connecting elements are formed as at least partly elastic elements.

The features of another embodiment extend to an electrically operated shaving apparatus in which the present invention has been carried over to, for example, the electrical shaving apparatuses marketed by applicant under the designation “Series 7, Type 790, 760, or 720.” Through these features, the automatic conformation of the operating head to the surface of the skin is simplified and thus improved. The additional lateral mobility of the operating head results in a shaving apparatus that provides the best shaving results with a high degree of protection of the skin, due to the flexible guiding of the operating head.

According to the features of another embodiment, the operating unit comprises at least two short hair trimmers that extend parallel alongside one another and at least one intermediate trimmer situated between them. This provides fast, thorough shaving results.

### BRIEF DESCRIPTION OF THE DRAWINGS

A number of exemplary embodiments of the present invention are shown in the drawing and are explained in more detail below.

FIG. 1 shows a highly schematized design sketch of a small appliance according to the present invention in a perspective view, from the top left, of the front and side faces, the retaining device being situated such that it enables a lateral displacement and pivoting perpendicular to the longitudinal axis of the handpiece, and the drive motor being integrated in the operating head, the operating head being pivotable toward the front and toward the rear about a pivot axis in the retaining device,

FIG. 2 corresponds to FIG. 1, but differs therefrom in that the drive motor is fastened in or on the handpiece between the guide means, separately from the pivotable operating head,

FIG. 3 corresponds to FIG. 1, but differs therefrom in that the drive motor is fastened in the retaining device separately from the pivotable operating head,

FIG. 4 shows a highly schematized design sketch of a small appliance according to the present invention in a perspective view, from the top left, of the front and side faces, the view corresponding essentially to that shown in FIG. 1, but differing therefrom in that now the pairs of connecting elements are situated not one behind the other but alongside one another, and the pivot axis of the operating head and drive motor runs from the front side to the rear side,

FIG. 5 corresponds to FIG. 4, but differs therefrom in that the drive motor is situated separately from the operating head, in or on the handpiece between the guide elements,

FIG. 6 corresponds to FIG. 4, but differs therefrom in that the drive motor is fastened in a stationary fashion in or on the retaining device,

FIG. 7 shows a perspective front view of a prototype of an electrically operated shaving apparatus corresponding to the specific embodiment shown in FIG. 2, in which the outer housing shells have been removed in order to show the guide means,

FIG. 8 shows a perspective partial view from the left of the shaving apparatus shown in FIG. 7,

FIG. 9 shows a front view of a second exemplary embodiment of a shaving apparatus corresponding to the specific embodiment shown in FIG. 1, differing from FIG. 7 in that on the one hand the outer cutter of the operating unit of the operating head has been removed in order to make visible the operating element, formed by undercutters, of the operating unit, and on the other hand the housing has been removed in order to show the guide means,

FIG. 10 shows an illustration corresponding to that shown in FIG. 9, but on a greatly enlarged scale, differing from FIG. 9 in that the operating head has been displaced toward the right side and pivoted slightly in the counterclockwise direction, and the operating head and the housing of the handpiece have been broken open in the center in order to show the drive device and the position of the guide means, which has been changed from that shown in FIG. 9 by the lateral displacement of the operating head, and

FIG. 11 corresponds to FIG. 10, but here the opposite position of the operating head is shown; i.e., the operating head is displaced not to the right but to the left, and is shown rotated slightly in the clockwise direction.

### DETAILED DESCRIPTION OF THE INVENTION

In FIGS. 1 through 6, small appliance 1 comprises a handpiece 2 in which on the upper end there are formed guide means 6 to which a retaining device 5 is fastened. In FIGS. 1 through 6, retaining device 5 serves to receive an operating head 3 that can be pivoted back and forth on retaining device 5 about a pivot axis 7, within predetermined limits. According to FIGS. 1 through 3, operating head 3 can be pivoted forward and back in the direction of arrow 10, while in FIGS. 4 through 6 it can be pivoted to the left and to the right in the direction of arrow 11. In the perspective views shown in FIGS. 1 through 6, front face and left side face 8, 9 are visible, while the rear face and right side face (which do not have position numbers) are obscured by front face and left side face 8, 9.

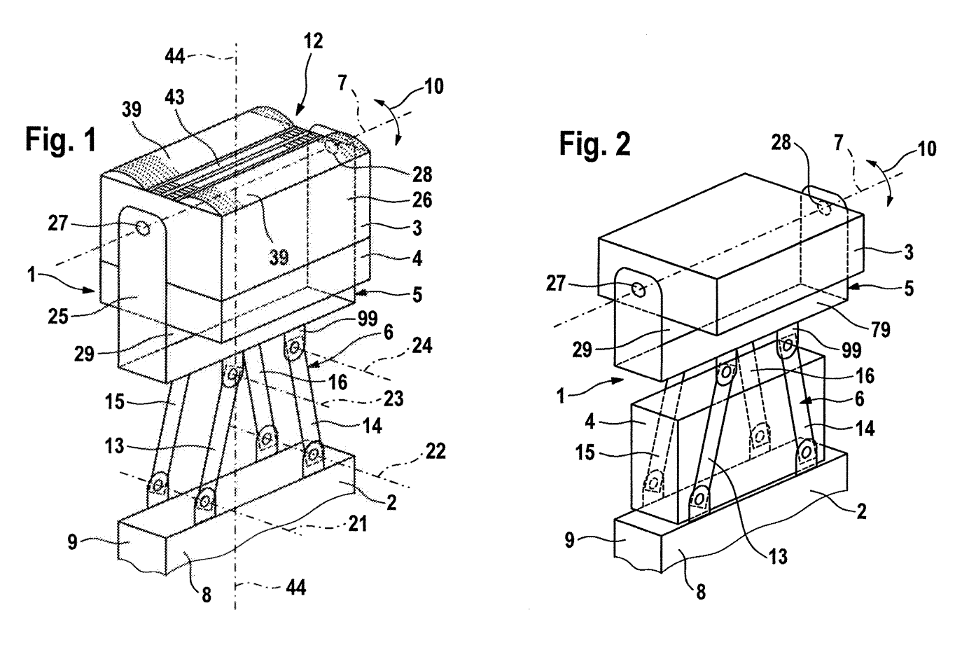

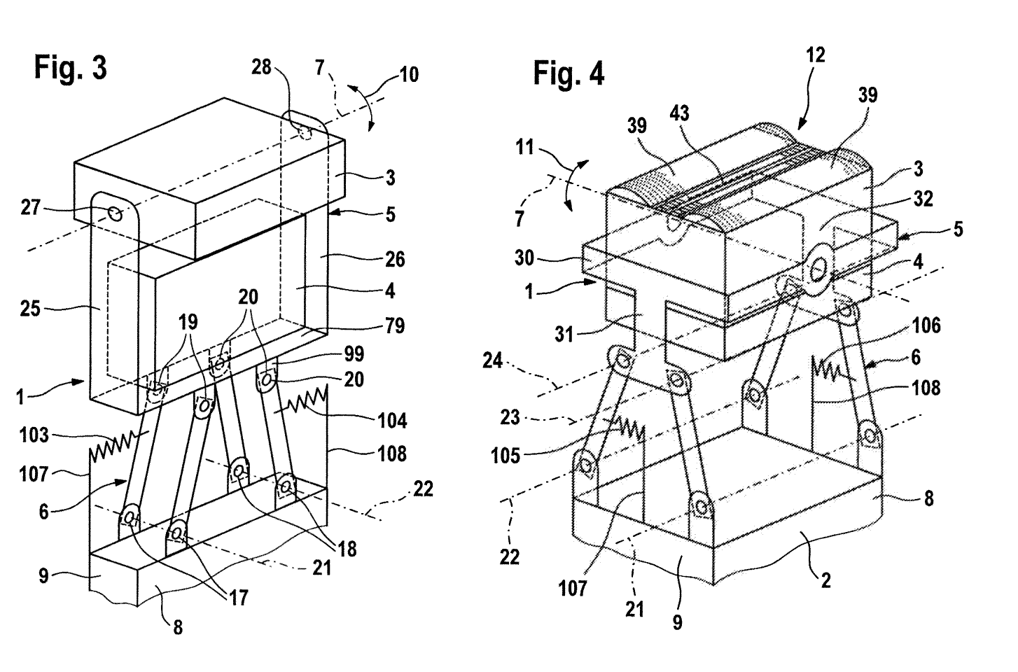

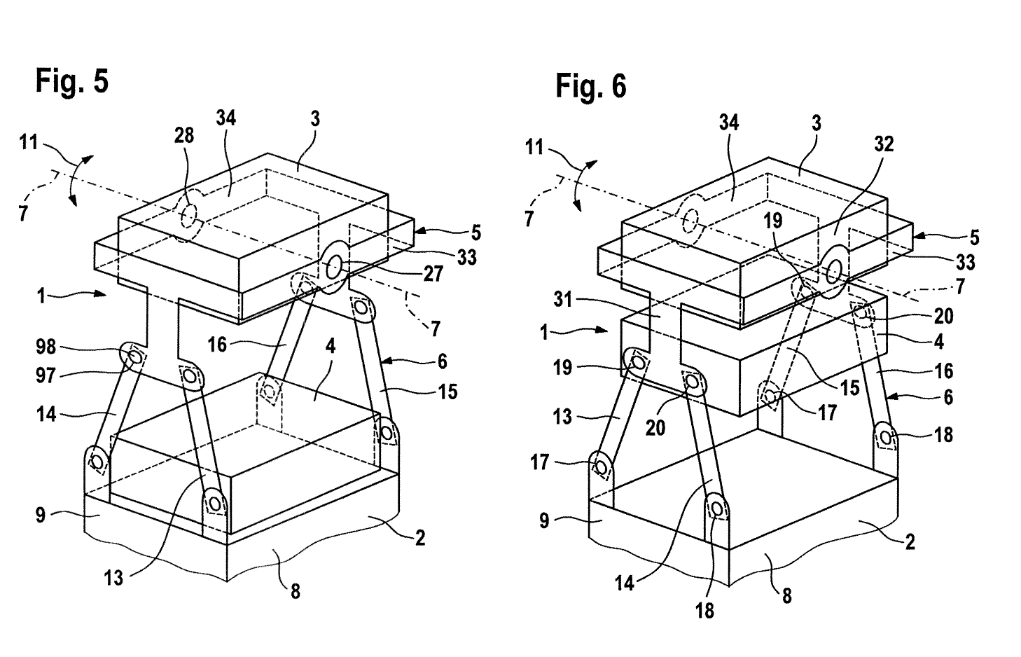

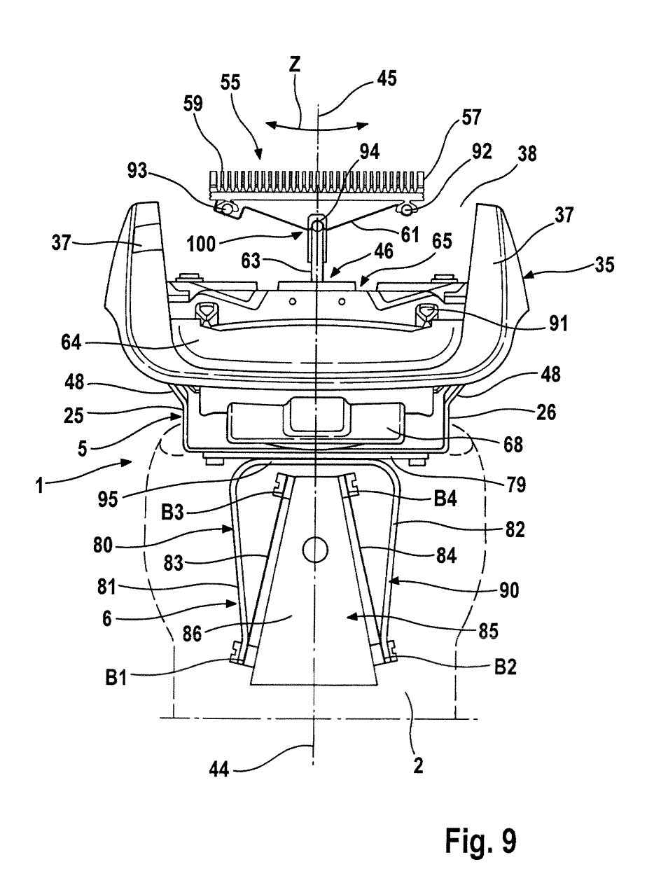

As can be seen only in FIGS. 1 and 4, on the upper side of operating head 3 an operating unit 12 is indicated that in FIG. 1 runs parallel to pivot axis 7 and in FIG. 4 runs perpendicular to said pivot axis. The way in which operating unit 12 runs according to FIG. 1 can also be carried over to FIGS. 2 and 3, and the run of operating unit 12 according to FIG. 4 can be carried over to FIGS. 5 and 6. In a shaving apparatus, operating unit 12 comprises one or more outer cutters 39 (FIG. 1, FIG. 4) and undercutters 55 (FIGS. 9, 10, 11); or, in an epilation device (not shown), operating unit 12 comprises a rotating plucking drum (not shown) having plucking elements that open and close. Operating unit 12 can be arranged in a rectilinear fashion or concentrically on operating head 3.

In FIGS. 1 and 3, a drive motor 4 that drives operating unit 12 is integrated into pivotable operating head 3. In FIGS. 2 and 4, drive motor 4 is disposed separately from operating head 3, on handpiece 2, between guide means 6. In FIGS. 3 and 6, drive motor 4 is also formed separately from operating head 3, on or in retaining device 5.

According to FIGS. 1 through 6, guide means 6 comprise two pairs of bar-shaped or rod-shaped connecting elements 13, 14, and 15, 16, which are connected to handpiece 2 via joint devices 17, 17 and 18, 18, and are connected to retaining device 5 via joint devices 19, 19 and 20, 20. Joints 17, 17 and 18, 18, or 19, 19 and 20, 20, which are situated behind one another, are each situated on joint axes 21, 22, 23, 24, which always extend parallel to one another. In the initial position of small appliance 1, the planes (not shown) that connect joint axes 21 to 22 and 23 to 24 preferably extend horizontally or perpendicular to center axis 44 of small appliance 1. When there is displacement of operating head 3, the position of the plane connecting upper joint axes 23 to 24 changes relative to center axis 44, while a plane connecting lower joint axes 21 to 22 remains unaffected thereby. However, this is the case only if the four-joint system is formed as a trapezoid as shown in FIGS. 1 through 8. If the four-joint system is formed as a parallelogram, the lower and upper planes always run in parallel. In FIGS. 1 through 6, the distance between lower joints 17, 18 is greater than the distance between upper joints 19, 20.

In FIGS. 1 through 3, the (preferably metal) retaining device 5 is formed substantially fork-shaped, such that the axial mounting 27, 28 for the creation of pivot axis 7 is formed on the two arms 25, 26. Arms 24, 26 [sic] are connected to one another via a base 79, on the underside of which joint devices 19, 20 are formed on four projections 99. According to FIGS. 1 and 3, operating head 3 and drive motor 4 are integrated in open space 29 formed between the two arms 25, 26. In open space 29 according to FIG. 2, only operating head 3 is integrated; here, drive motor 4 is inserted between connecting elements 13 through 16, which form guide means 6.

According to FIGS. 4 through 6, retaining device 5 comprises an essentially quadrangular frame 30 from which arms 31, 32 project downward at the side faces, the arms widening toward the sides at their ends and thus serving to accommodate upper articulations 19, 20. Axial bearings 27, 28 and pivot axis 7 are formed centrically on front and rear side 33, 34 of frame 30. Pivot axis 7 runs centrically above the two pairs of connecting elements 13, 14 and 15, 16.

According to FIGS. 1 through 6, upper and lower joint devices 19, 20 comprise pins 98 that engage so as to be capable of rotation in bores 97, pins 98 being advantageously formed on connecting elements 13, 14, 15, 16. Pins 98 are secured (not shown) in bores 97 against sliding out. In FIGS. 3 and 4, springs 103, 104 or 105, 106 engage on connecting elements 14, 15 or 14, 16, the springs holding operating head 3 in its depicted center position if no lateral force acts on the operating head. In the other FIGS. 1, 2, these springs 103, 104 have been omitted for the sake of simplicity, but are of course also present there. The same holds for FIGS. 5 and 6, in which springs 105, 106 are not shown. Springs 103, 104, 105, 106 are supported in handpiece 2, which is indicated by webs 107, 108.

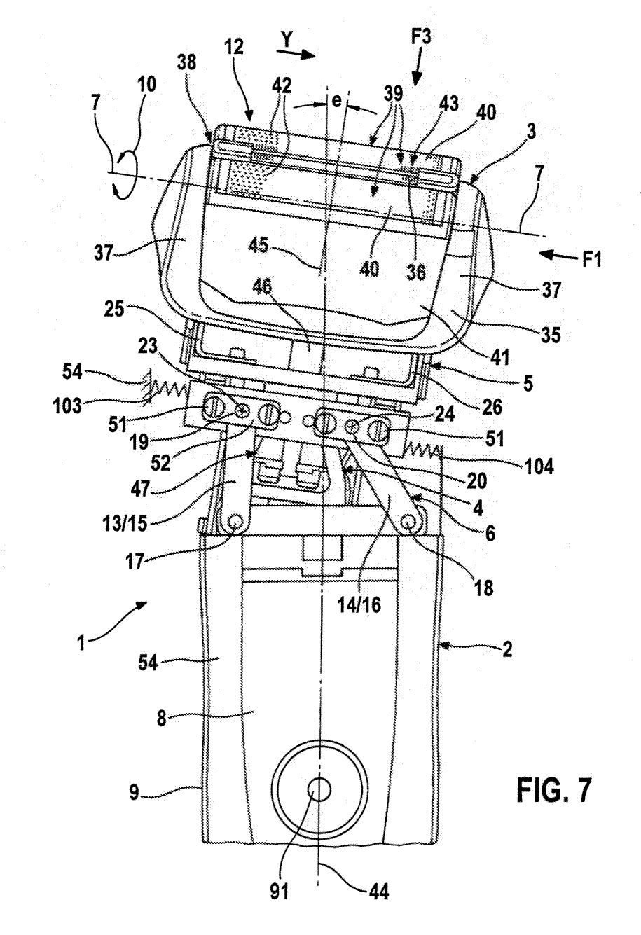

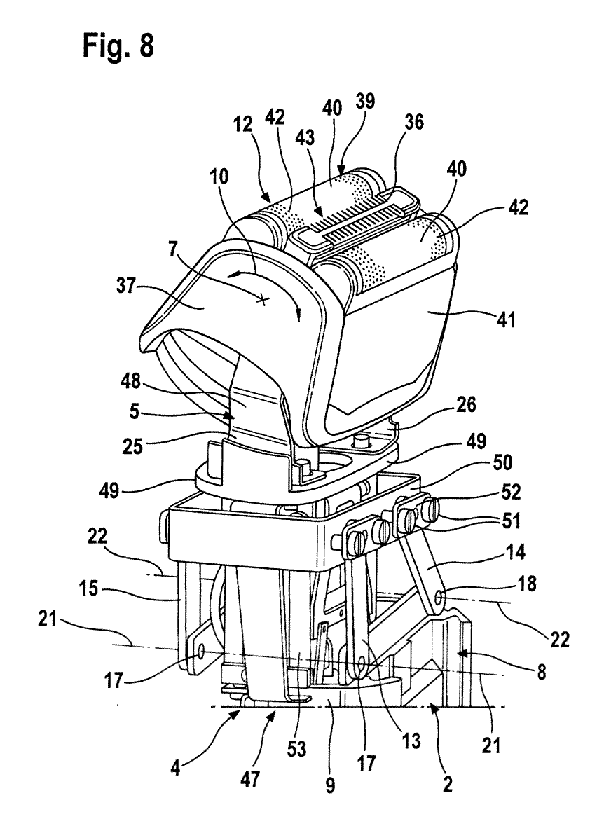

FIGS. 7 and 8 show an exemplary embodiment of a small appliance 1 as a shaving apparatus, in which, after removal of the front housing shell of handpiece 2, the guide means 6 are visible that enable the lateral movement of operating head 3. Because this is a depiction of a prototype, the parts do not correspond to a series production. Nonetheless, this embodiment can be used to explain the basic configuration and manner of operation of a shaving apparatus 1 according to the present invention. Only retaining device 5, operating head 3, and parts of handpiece 2 originate from a series production of a shaving apparatus that has been marketed by applicant for some time, “Series 7, Type 790, 760, or 720.”

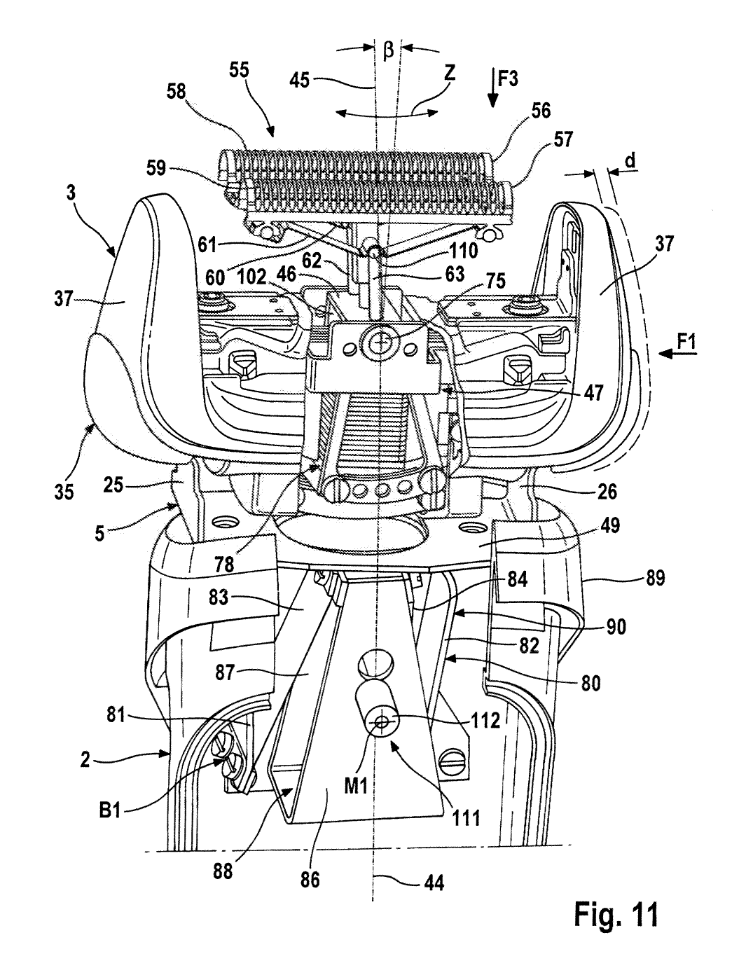

According to FIGS. 7 and 8, operating head 3 comprises a cutting head frame 35 that is U-shaped so as to be upwardly open, in the receiving space 38 of which that is formed between the two limbs 37, operating unit 12 comprising outer cutters 39 and undercutters (not shown), is detachably snapped in. In FIGS. 7 and 8, the undercutter is not visible, because it is occluded by foil-type outer cutters 39 and front and rear side walls 41 connected thereto. The rear side wall of operating unit 12 is also not visible in FIGS. 7 and 8. According to FIGS. 7 and 8, the two outwardly situated outer cutters 39 comprise two shaving foils 40 that are situated parallel to one another and are curved upward, having many small openings 42 through which hairs pass; only some openings 42 of which are shown in the form of points by way of example. An intermediate trimmer 43, of which likewise only outer cutter 36 is visible, is formed between the two shaving foils 40. The associated undercutters are not shown in FIGS. 7 and 8. The three outer cutters 39, 36, 39 can sink down from above, by different amounts or by the same amount, toward receiving space 38, against the force of springs 60, 61 (FIG. 11), so that their surfaces can conform optimally to the skin surface of a user.

As FIGS. 7 and 8 show, due to the trapezoidal suspension of retaining device 5, the action of a lateral force F1 has caused operating head 3 to be on the one hand displaced to the left relative to handpiece 2, and on the other hand also to be rotated slightly in the clockwise direction, such that center axis 45 of operating head 3 is inclined relative to longitudinal axis 44 of handpiece 2 by the angle e. In the initial position of shaving apparatus 1, however, center axis 45 of operating head 3 extends vertically, and is thus aligned with longitudinal axis 44 of handpiece 2. In this initial position, axes 44, 45 form the axis of symmetry of shaving apparatus 1. Pivot axis 7 of the operating head then runs horizontally, or perpendicular to longitudinal axis 44; however, this is not visible in FIGS. 7 and 8. Lateral force F1 is the reaction force to the displacement force introduced during shaving via handpiece 2, and therefore results substantially from contact force F3 times the coefficient of friction between the skin of a user and the metal surface of outer cutter 39.

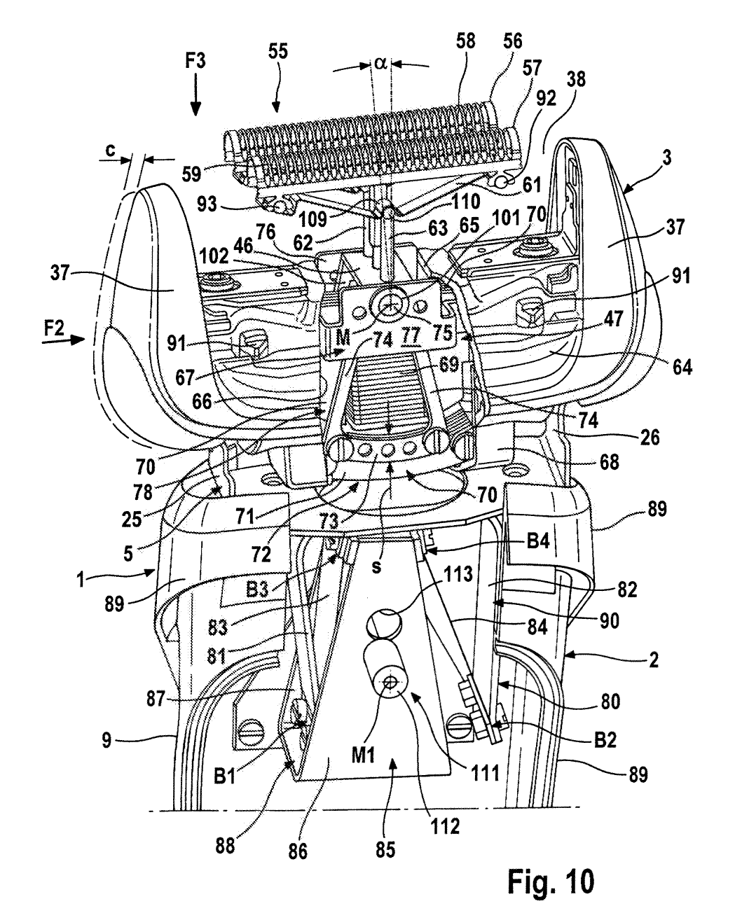

As can also be seen in FIG. 7, a drive element 46 protrudes from the upper side of handpiece 2; the drive element engages in operating head 3 and is connected to undercutters 55 via coupling means 100, shown for example in FIGS. 9 through 11. The oscillatory movement of drive element 46 is transmitted to undercutters 55 via coupling means 100. Drive element 46 is connected to a drive motor 47, which is not described in more detail here, however, because it corresponds to drive motor 47 as shown in FIGS. 10 and 11 and is explained in more detail only in connection therewith.

According to FIG. 8, arms 25, 26 of retaining device 5 are angled slightly toward the center in their center area 48, and end at a ring 49 that surrounds drive element 46 with play. Ring 49 is connected fixedly to a frame 50 on the front and rear side of which there are formed upper joints 19, 20, which are connected in an articulated fashion at the front side to front connecting elements 13, 14 and at the rear side to rear connecting elements 15, 16. Screws 51 shown in FIGS. 7 and 8 hold link plates 52 fixedly on frame 50, joints 19, 20 being formed centrically on the two front and rear link plates 52. This embodiment presents this solution here only because shaving apparatus 1 is a trial model. In series production, for example the frame would be formed in one piece with retaining device 5, and joints 19, 20 would be integrated directly in frame 50 and in connecting elements 13 through 16, as is the case for lower joints 17, 18.

According to FIGS. 7 and 8, resting drive part 53 of drive motor 4 is fastened to a housing segment 54 of handpiece 2. Likewise, the lower ends of connecting elements 13 through 16 are mounted via their joints 17, 18 to housing part 54 in an articulated fashion. Springs that always return operating head 3 to its center position in the resting position of the shaving apparatus are not shown here. In front side 8 of handpiece 2, according to FIG. 7 there is integrated an electrical on-off switch 91 that can be externally actuated in order to switch drive motor 47 on or off. FIG. 7 also shows sketches of springs 103, 104 that engage laterally on frame 50 and that are supported on a housing segment 54 of handpiece 2. Springs 103, 104 always return the operating head to its center position as soon as the influence of the spring forces is greater than forces F1, F3 acting on operating head 3, or as soon as a shaving process has terminated.

FIGS. 9 through 11 show a further specific embodiment of a shaving apparatus 1, in which, differing from shaving apparatus 1 according to FIGS. 7 and 8, guide means 6 do not comprise a lever drive mechanism, but instead comprise plate springs 83, 84, formed on both sides of longitudinal axis 44, by which operating head 3 is borne and guided. FIG. 9 shows the center position of operating head 3 relative to handpiece 2; the segment shown here of a shaving apparatus 1 is shown in a significantly smaller scale than is the segment of the shaving apparatus shown in FIGS. 10 and 11.

FIG. 10 shows a position of operating head 3 in which forces F2 and F3 have caused the operating head to be displaced to the right by distance c, while simultaneously rotating counterclockwise by a small angle a. According to FIG. 11, a lateral force F1 acts on operating head 3 from the right and a force F3 acts on operating head 3 from above, such that the operating head has moved to the left by distance d while rotating clockwise by a small angle β. This movement of operating head 3 is due to the way in which operating head 3 is suspended on plate springs 82, 83, which is explained in more detail below.

In FIGS. 9 through 11, outer cutters 39 of operating unit 12 (FIGS. 7, 8) have been removed from operating head 3, so that undercutters 55, associated with the two outer shaving foils 40 (FIG. 8), are visible. The undercutter of intermediate trimmer 43 (FIGS. 7, 8) is not shown in FIGS. 9 through 11 for simplicity, but is of course also present. Here, undercutters 55 comprise two cutter blocks 56, 57 that run perpendicular to longitudinal axis 44, on which upward-curved blades 58, 59 are formed that are situated perpendicular to cutter blocks 56, 57. Cutter blocks 56, 57 are connected at their underside to shaped springs 60, 61 that are pivotably snapped onto T-shaped drive rods 62, 63. Drive rods 62, 63 are connected to drive element 46 of drive motor 47, such that when drive motor 47 is switched on, an oscillatory back-and-forth movement is transmitted via drive rods 62, 63 to shaped springs 60, 61, and from there to undercutters 55 in direction Z.

While in FIGS. 7 and 8 drive motor 47 is fixed to handpiece 2 below operating head 3, in FIGS. 9 through 11 drive motor 47, which is constructed in the same way, is integrated in operating head 3. For that purpose there is formed in base 64 that connects the two limbs 37 an opening 65 through which drive motor 47 passes upwardly, and on the walls 66 of which housing 67 of drive motor 47 is fixedly anchored. This is visible in FIGS. 10 and 11, because here both base 64 and housing part 68, which encloses drive motor 47 from below (as can be seen in FIG. 9), have been broken open toward the front.

Drive motor 47 comprises a coil 69 that is wound around an inner segment (not shown) of an iron core 70. Iron core 70, which extends upward from coil 69 at the sides, is fastened in opening 65 of operating head 3 via fastening means that are not shown in the drawing. Iron core 70 runs externally around coil 69 in order to obtain a closed magnetic circuit. Between lower segment 71 of iron core 70 and the lower end of coil 69 there is formed a gap 72, in the shape of a segment of a ring, having constant gap width s, in which abase 73, which bears two magnets (not shown) that are situated at a distance from one another and which have the shape of ring segments, can be moved back-and-forth almost without play. The walls of gap 72 and the radially running walls of base 73 describe radii having common midpoint M.

According to FIGS. 10, 11, base 73 is connected via four webs 74, 102 (two in front, two at the rear), in a manner similar to a swing boat, to a torsion shaft 75, the midpoint of which is situated at M. Together with the embedded magnets and webs 74, 102, base 73 forms rotor 78 of drive motor 47, the rotor 78 being pivotable about M in an oscillatory fashion. Torsion shaft 75 is rotationally fixed, preferably through welding, pressing, gluing, etc., to a rear bearing shield 76 that is in turn flange-mounted on the iron core. From the rear fastening point (not shown), torsion shaft 75 runs toward the front, and is rotatably mounted in a front bearing shield 77, in a mating bore 101.

The two webs 74 located in the front in the drawing are fastened in a rotationally fixed fashion to torsion shaft 75 behind front bearing shield 77, preferably by welding, pressing in, gluing, etc. The rear two webs 102 shown in the drawing are rotatably mounted on torsion shaft 75 in front of rear bearing shield 77. In this way, starting from the front point at which front webs 74 are fastened to torsion shaft 75 up to the point at which torsion shaft 75 is fastened to rear bearing shield 76, there results a clamping length (not shown) through which, as a function of the material (preferably spring steel wire) and as a function of the dimensions of torsion shaft 75, there results a torque, defined as a function of the angle of rotation, as a torsion force through which the maximum pivot angle of rotor 78 is defined as a function of the magnetic forces of the magnets and of coil 69. The oscillation frequency is determined by the frequency of the reversal of polarity of coil 69. Through the torsion force, rotor 78 is always moved back to its center position (not shown).

According to FIGS. 9 through 11, base 79 of retaining device 5 is connected to U-shaped frame part 80 that is downwardly open, the two limbs 81, 82 of which run symmetrically to longitudinal axis 44 in the rest position of the shaving apparatus (FIG. 9). Limbs 81, 82 run toward one another up to their free ends, and have at their free ends the same distance from longitudinal axis 44. Frame part 80 is made of a material that is flexurally rigid, preferably metal, so that it can accept forces acting thereon without undergoing large deformation. On free ends B1 and B2 of limbs 81, 82 there are fastened plate springs 83, 84 that, in FIGS. 9, 10, 11, run upward in the direction of foot 95 and that are fastened to fastening points B3 and B4 of a bearing member 85 that is pivotably mounted on housing 89 of hand piece 2. The fastening of plate springs 83, 84 to bearing member 85 and to frame part 80 can take place through point welding, gluing, screwing, or some other type of fastening known to a design engineer. Bearing member 85 is pivotably mounted on hand piece 2 via a bearing 111, such that the transverse forces F1, F2 that occur during shaving can be partly absorbed in bearing member 85 by its slight pivoting about pivot midpoint M1, whereby the operating head is displaced laterally in the direction c or d according to the present invention.

Bearing member 85 is essentially U-shaped, seen in a side view, and has two oppositely situated arms 86, 87 that taper upwards, between which an open space 88 is formed. This open space 88 serves to allow plate springs 83, 84, which are connected to limbs 81, 82, to sink in when operating head 3 pivots to the sides according to FIGS. 10 and 11. Bearing 111 comprises a bearing axle 112, which penetrates bores 113 provided in arms 86, 87, and which is mounted on housing 89 of the handpiece. Bearing axle 112 has slings (not shown) that fix bearing part 85 in housing 89 of handpiece 2. In FIGS. 10 and 11, the housing shell that forms front 8 of handpiece 2 has been removed in order to show guide means 90 for pivoting operating head 3 to the sides.

The manner of operation of the present invention is first explained on the basis of FIGS. 7 and 8, the specific embodiment according to FIG. 2 corresponding in its functioning and basic design to this specific embodiment. Concerning the kinematics of guide means 6 for moving the operating head, the specific embodiments according to FIGS. 1, 3, and 4 through 6 shall be applied in this explained sense, because in all these embodiments a trapezoidal shape is used as guide means 6, which is also the case in the exemplary embodiment shown in FIGS. 7 and 8.

In the initial position of the shaving apparatus according to FIGS. 7 and 8, center axis 45 is aligned with longitudinal axis 44; i.e. operating head 3 and handpiece 2 are situated essentially symmetrical to these axes 44, 45. If drive motor 47 is now set into operation using on-off switch 91, drive element 46 moves in an oscillatory fashion from left to right and vice versa, carrying along with it undercutters 55 associated with outer cutters 39. A relative movement arises between outer cutters 39 and undercutters 55, such that the hairs penetrating into openings 42 are sheared off by undercutters 55. In the process, the surface of outer cutters 39 of operating unit 12 is pressed against the surface of the skin (not shown) of a user. If handpiece 2 is moved in the process, according to FIG. 7, in direction Y, then frictional force F1 acting on operating unit 12 causes it to move to the left relative to hand piece 2, as is shown in FIGS. 7 and 8.

Because operating head 12 is connected in an articulated fashion via the four joints 19, 20 to connecting elements 13, 14, 15, 16, which in turn are connected in an articulated fashion to handpiece 2 via joints 17, 18, operating head 3 describes a movement relative to handpiece 2 that on the one hand takes place laterally to the left and on the other hand enables a pivoting in the clockwise direction about joints 17, 18, 19, 20, connecting elements 13, 14, 15, 16 creating the connection of lower joints 17, 18 to upper joints 19, 20.

Springs 103, 104 acting laterally on frame 50 ensure that operating head 3 returns to its center position when forces F1, F3 cease to be applied to operating head 3 by the surface of the skin. Simultaneously with the pressing of operating head 12 against the surface of the skin, outer cutters 39, with their undercutters 55, are also moved into or out of receiving space 38, depending on how large or small contact pressure force F3 is. In addition, operating head 3 can pivot toward the front or toward the rear about its pivot axis 7 when shaving apparatus 1 is moved transverse to pivot axis 7 and outer cutters 39 are in contact with the skin. The spring-loaded lowering of operating unit 12 into operating head 3, as well as the pivoting of operating head 3 about its pivot axis 7, have long been known in the prior art.

Guide means 5 according to the present invention for the lateral displacement or offset of operating head 3 are, in contrast, already novel regarded in themselves, and lead to better shaving results. If, for example, joints 17, 18, 19, 20 were to form a parallelogram on each side, according to the present invention only a lateral displacement of operating head 3 would result relative to longitudinal axis 44. In this arrangement, center axis 45 of operating head 3 would always run parallel to longitudinal axis 44, but operating head 3 would in addition move closer to handpiece 2 during the lateral movement. Pivot axis 7 also always runs perpendicular to longitudinal axis 44 of handpiece 2 in this arrangement. If joints 17, 18, 19, 20 on each side form a trapezoid, as is the case in FIGS. 1 through 8, then in addition to the lateral movement a pivot movement of operating head 3 about joints 17, 18, 19, 20 is also added. Because the course of movement of operating head 3, due to the large number of possible lever geometries, can easily be understood using a compass and a pencil, a precise description of the movement path of operating head 3 will be dispensed with here.

The manner of operation of the present invention on the basis of the specific embodiment shown in FIGS. 9 through 12 is as follows. Here as well, of course, before shaving begins, outer cutter 39 must first be inserted into receiving space 38 of operating head 3, as is the case in FIGS. 7 and 8. Locking means 91 then engage in side walls 41 of outer cutter 39, and hold same stationary on operating head 3. In this position, undercutters 55 are pressed against the underside of outer cutter 39 in a spring-loaded fashion by strip-shaped springs 60, 61.

Springs 60, 61, which are relaxed according to FIGS. 9 through 11, are held at right fastening point 92 in a fixed bearing, and are held at left fastening point 93 in a movable bearing. In this way, these springs can move toward the left side on movable bearings 93 during pre-tensioning of springs 60, 61, without undercutters 55 also moving to the left. Center clamping points 94 of springs 60, 61 on their associated drive rods 62, 63 have no play, and therefore are also displaced slightly to the left together with drive rods 62, 63. When there is bending of shaped springs 60, 61, there also occurs a slight rotation between drive rods 62, 63 and center clamping points 94. For this purpose, shaped springs 60, 61 have semicircular segments 109 that partly surround, with pre-tensioning, transverse pins 110 that are disposed on the free ends of drive rods 62, 63 and that run perpendicular to the rods. Together with the drive rods, transverse pins 110 form T-shaped structures. Due to springs 61, undercutters 55 always abut the undersides of outer cutters 39, so that when there is external pressure against the forces of springs 60, 61, operating unit 12 can move into receiving space 38 of operating head 3.

After drive motor 47 is switched on, coil 69 is supplied (via lines that are not shown) with pulsed current, such that the alternating magnetic field produced in the magnet core by coil 69 on the magnets integrated in rotor 78 moves the motor back and forth in an oscillating fashion about midpoint M by a small angle β. Base 73 of rotor 78 is made of a plate packet, as is iron core 70. In FIG. 10, rotor 78 has pivoted clockwise by the angle a relative to center axis 45 of coil 69 through which iron core 70 passes. Because drive rods 62, 63 are fixedly connected to rotor 78, they execute an oscillatory movement about midpoint M that pivots to the left or to the right. This movement is communicated to undercutters 55 via springs 60, 61, but undercutters 55 receive only the movement parallel to outer cutters 39, while the perpendicular movement component that arises along with the slightly circular movement of drive rods 62, 63 is resiliently absorbed in springs 60, 61, and, due to the slight rotation, the component is received in segments 109 of springs 60, 61 in that transverse pins 110 of drive rods 62, 63 slide in a concentric fashion in these segments 109.

Because operating head 3 is connected, via guide means 6 formed as springy connecting elements 83, 84, to bearing member 85, which is capable of pivoting in housing 89 of handpiece 2 via bearing 111, vibrations (reaction forces) produced by drive motor 47 during operation are also transmitted to operating head 3, so that this operating head exerts slight oscillating vibrations corresponding to the vibrations of drive motor 47, the vibrations running substantially transverse to center axis 45, so that these vibrations further promote good shaving results. This is because through the vibrating back-and-forth sliding of outer cutters 39 on the skin surface of a user, larger shaving surfaces can be reached in the shortest time.

In addition to this vibration of operating head 3, caused by drive motor 47, when outer cutters 39 are pressed against the skin surface of a user with simultaneous displacement parallel to the skin surface, the operating head is laterally displaced in sliding direction Z, and is additionally further pivoted about fastening points B3, B4. An eccentric pressure force F3 that may act from above on operating head 3 further promotes the pivoting.

Because, according to FIGS. 9 through 11, drive motor 47 in operating head 3 itself, and operating head 3, is fixedly connected via base 79 of fork-shaped retaining device 50 to foot 95 of frame part 80, this system is suspended via downward-running limbs 81, 82 on plate springs 83, 84, which are fastened at B1 and B2 to limbs 81, 82 and at B3 and B4 to bearing member 85. If during shaving according to FIG. 10 a frictional force F2 is applied from the left to the side face of limb 37 on operating head 3, this force F2 is transmitted via operating head 3 onto retaining device 5 and from there to guide means 90, which bring a resilient yielding of operating head 3 out of its center position according to FIG. 9 into its position shown in FIG. 10. In the process, plate springs 83, 84 bend in their longitudinal direction between clamping points B3, B1 and B4, B2. This movement is further promoted in that bearing part 85 pivots slightly in the counterclockwise direction about its pivot midpoint M1. Associated slightly bent plate springs 83, 84 exert a resetting force on fastening points B1 and B2 that causes operating head 3 to return automatically to its initial position as soon as the contact of outer cutters 39 with the surface of the skin has ceased. Thus, operating head 3 is suspended on plate springs 83, 84 literally so as to float to the side by the dimensions c, d, both clockwise and counterclockwise, by angles a, β.

Because the broad sides of plate springs 83, 84 run substantially perpendicular to transverse forces F2 that act on operating head 3, operating head 3 is mounted with particular spring elasticity in this direction due to the low moment of resistance. In contrast, when forces act from the front toward the rear or vice versa on plate springs 83, 84, these springs exert a high tensile strength due to their large moment of resistance. The movement of operating head 3 in the direction from the front to the rear or vice versa takes place exclusively via pivot axis 7 if operating head 3 is pivotably mounted on arms 25, 26 formed on retaining device 5, as is the case according to FIGS. 9 through 11.

If, according to FIG. 11, forces F1 and F3 are exerted on operating head 3 from the right, these forces are transmitted via fastening points B1, B2 to plate springs 83, 84, and from there to fastening points B3, B4. Here, a counterclockwise torque acts on bearing part 85, causing a slight rotation of bearing part 85 about its pivot midpoint M1, causing fastening points B3, B4 to rotate counterclockwise about M1. In addition, operating head 3 is displaced to the left through the action of this force, because plate springs 83, 84 bend. In this way, operating head 3 is displaced by distance d to the left, and is simultaneously rotated clockwise by angle β.

Angle a is determined between the plumb line to foot 95 of frame part 80 in its initial position and the plumb line to foot 95 pivoted counterclockwise, while angle β is determined between the plumb line to foot 95 in the initial position and the plumb line to foot 95 pivoted clockwise.

Guide means 90 shown in FIGS. 1 through 11 enable a better conformation of operating head 3 to the surface of the skin of a user during shaving. This is achieved on the one hand through the lateral displacement of operating head 3 (distances c, d) and the simultaneous pivoting (angles a, β) about fastening points B3, B4, and on the other hand by the additional pivoting of operating head 3 about its pivot axis 7 and the floating bearing of upper and undercutters 39, 55 in operating head 3, so that the sliding surface of outer cutters 39 can follow almost any contour of the surface of the skin.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. An electrical small appliance for removing hairs, having a handpiece that runs in the direction of a center axis and that is provided with a front side and a rear side as well as with side faces, and having a operating head fastened to the handpiece via a retaining device, the operating head having a operating unit that comprises at least one operating element that is set into motion via an operating element by an electric drive motor formed in the small appliance, such that when the operating unit glides along the skin surface of a user, hair is removed by the operating unit, wherein the retaining device is connected to the handpiece via guide means in such a way that when a force acts on the operating head in the guiding direction, at least a lateral displacement of the operating head takes place relative to the handpiece.

2. The small appliance according to claim 1, wherein the operating head can be brought into its initial position each time the application of force is terminated, by springy resetting means.

3. The small appliance according to claim 1, wherein the guide means comprise at least two connecting elements that are situated at a distance from one another and that are connected, via joint devices, both to the retaining device and to the handpiece.

4. The small appliance according to claim 2, wherein four connecting elements connect the retaining device and the handpiece by means of eight joint devices, and in that each two connecting elements are situated at the same height, and form a four-joint system with the retaining device as well as with the handpiece.

5. The small appliance according to claim 4, wherein the four-joint system is a parallelogram.

6. The small appliance according to claim 4, wherein the four-joint system is a trapezoid.

7. The small appliance according to claim 3, wherein the joint devices have joint axes that run parallel to one another and in the direction from the front side to the rear side of the handpiece.

8. The small appliance according to claim 3, wherein the joint devices have joint axes that run parallel to one another and in the direction toward the side faces of the handpiece.

9. The small appliance according to claim 7, wherein the joint devices comprise pins that run in bores.

10. The small appliance according to claim 3, wherein the joint devices comprise film hinges.

11. The small appliance according to claim 1, wherein the guide means comprise at least two connecting elements that are situated at a distance from one another and that have at least partly springy segments.

12. The small appliance according to claim 11, wherein, on the retaining device there are formed limbs extending in the direction of the handpiece, and in that between the limbs, in the vicinity of the retaining device, there is formed a bearing part connected to the handpiece, in that fastening points are formed on the free ends of the limbs and on the bearing part, and in that a springy segment is clamped in each case between the fastening points.

13. The small appliance according to claim 12, wherein the bearing part itself is mounted so as to be pivotable about a bearing point in the housing of the handpiece, wherein the bearing point is situated between the fastening points.

14. The small appliance according to claim 11, wherein the springy segments are formed completely from plate springs.

15. The small appliance according to claim 12, wherein the ends of the plate springs are welded, screwed, riveted, or glued to the retaining device and to the handpiece.

16. The small appliance according to claim 3, wherein the operating unit can be movably raised and lowered in the operating head, in that the operating head is mounted on the retaining device so as to be pivotable about a pivot axis, in that the pivot axis of the operating head, in the center position and in a vertical top view of the front side of the small appliance, runs perpendicular to the longitudinal axis of the handpiece, in that the guide means are situated on the retaining device and on the handpiece in such a way that a lateral displacement of the operating head to the right and to the left is possible, and in that the operating unit runs in the direction toward the pivot axis.

17. The small appliance according to claim 3, wherein the operating unit can be movably raised and lowered in the operating head, in that the operating head is mounted on the retaining device so as to be pivotable about a pivot axis, in that the pivot axis of the operating head, seen in a vertical top view of the side face of the small appliance, runs horizontally and in the direction from the front side to the rear side of the handpiece, in that the guide means are situated on the retaining device and on the handpiece in such a way that a displacement of the operating head in the direction of the side faces of the handpiece is possible, and in that the operating unit runs transversely to the pivot axis.

18. The small appliance according to claim 16, wherein both the operating head and the drive motor are formed on the retaining device.

19. The small appliance according to claim 18, wherein the drive motor is also formed in the operating head.

20. The small appliance according to claim 16, wherein the operating head is situated separately from the drive motor in the retaining device.

21. The small appliance according to claim 16, wherein the operating head is formed in the retaining device, and the drive motor is formed in the handpiece.

22. The small appliance according to claim 3, wherein the operating unit comprises a rotating plucking drum on which clamping elements are formed as operating elements that open and close when the plucking drum rotates, such that as the plucking drum glides along the surface of the skin of a user hairs are clamped and are subsequently plucked out as the rotation continues.

23. The small appliance according to claim 3, wherein the operating unit comprises at least one undercutter as an operating element and at least one outer cutter made from thin sheet metal, in that the outer cutter has many openings through which hairs penetrate, and in that when the outer cutter glides along the skin surface of a user, hairs penetrating through the openings are caught and are sheared off by the undercutter.

24. The small appliance according to claim 23, wherein the operating unit comprises at least two short hair trimmers that run parallel alongside one another, and at least one intermediate trimmer situated between them.
